(19) United States
(12) Patent Application Publication
(10) Pub. No.: US 2004/0145679 A1
(43) Pub. Date: Jul. 29, 2004

(54) Method of transmitting images for online publication

(76) Inventor: Dong-Hee Kim, Seoul (KR)

Correspondence Address: GREENBLUM & BERNSTEIN, P.L.C., 1950 ROLAND CLARKE PLACE, RESTON, VA, 20191, US

(21) Appl. No.: 10/475,527

(22) PCT Filed: Jan. 28, 2002
(86) PCT No.: PCT/KR02/00127

(30) Foreign Application Priority Data
Jan. 29, 2001 (KR) 2001-04020
Nov. 27, 2001 (KR) 2001-74266

(51) Int. Cl. H04N 7/16; H04N 11/04; H04N 11/02; H04N 7/12; H04N 5/38

(52) U.S. Cl. 348/398.1; 348/397.1; 725/146; 725/147; 348/723

(57) ABSTRACT

The present invention relates to a method transmitting images of an on-line publication wherein images with appropriate resolution are automatically selected and transmitted to the client according to a response of the client, thereby largely increasing the transmission speed without interfering the client's reading of the publication.

### 1. TECHNICAL FIELD

The present invention relates to a method of transmitting images for online publication, more particularly to a method of transmitting images for online publication by considering a type of reading at off-line, thereby rapidly transmitting the images without interfering a convenience of the reading.

### 2. BACKGROUND ART

Nowadays, a system for using Internet has been establishing at home as well as companies, and so Internet becomes an indispensable means for a communication or information transmission. Additionally, taking advantage of this tendency, even in the publishing business, a system, that converts contents of a publication to a digital file (it is called as online publication) and transmits the file to clients at online, is established, and it is expected that the online publication will be popular in the near future.

However, when a reader reads a publication which has relatively many pictures, for example an advertising publication such as a magazine or a catalogue, the reader immediately turns over a page if it is recognized by his instant recognition through the sense of sight that the page is not interesting, while the reader remains at a page and reads this page with attention if the page is interesting for him.

Meanwhile, in case of this online publication, specially an online publication transmitted to a client (hereinafter, this term means a user and a personal computer of the user, as long as it is not necessary to distinguish these two terms) in a type of image data due to many pictures in its content, data amount per page is normally enormous to be several hundreds Kb to several Mb, and so considerable time is required although ultra high speed line for exclusive use for Internet is used.

Nevertheless, in the past, high-resolution integrated images for all pages was transmitted for an online publication, not considering the reading type for the above mentioned offline publication, and so communication lines and time happened to be wasted due to pages in which the client was not interested. Due to this problem, clients have an opinion that the online publication is served with a slow transmission speed to be inconvenient. Accordingly, the online publication has a disadvantage that it is not able to be popular.

Meanwhile, in case of the online publication, its content is transmitted in an incorporeal type between people without having any direct contact with each other, and it can be simultaneously transmitted in a bundle through the communication network. Accordingly, measures for preventing the illegal reproduction become an important matter for the provider.

However, in case of the related online publication, in order to insert the tracking information into image data, the inserting process is performed with whole integrated images, and so the amount of work is enormous, thereby causing an overload to the server.

### DISCLOSURE OF INVENTION

It is an object of the present invention to provide a method transmitting images of an on-line publication as mentioned above wherein images with appropriate resolution are automatically selected and transmitted to the client by analyzing response of the client, thereby largely increasing the transmission speed without interfering the client's reading of the publication.

It is another object of the present invention to a method transmitting images of an on-line publication wherein in a step of inserting the information tracking the illegal reproduction, the insertion is made into a divided part of the image, thereby largely reducing an amount of the insertion operation.

To achieve the above object, there is provided a method of transmitting images for an online publication performed by a provider of the online publication in a state that the provider and a client having a stretching function and a multi tasking function are connected to each other through a communication network, comprising steps of a) preparing, for a same original copy, relatively low-resolution integrated images and relatively middle-resolution integrated images which are to be transmitted to the client and magnified by the stretching function; b) transmitting the corresponding low-resolution integrated image when a transmission for a certain page of the original copy is requested; c) determining if a request for a transmission of another page of the original copy is made until a certain time passes after the transmission of the low-resolution integrated image; d) transmitting, if it is determined at the step (c) that a request for a transmission of another page is made before the certain time passes, the low-resolution integrated image for the page; and e) transmitting, if it is determined at the step (c) that a request for a transmission of another page is not made until the certain time passes, the middle-resolution integrated image for the certain page.

In the above mentioned method, after the transmission the low-resolution integrated image or the middle-resolution integrated image is completed, when the low-resolution integrated images or the middle-resolution integrated images for predetermined relevant pages to the certain page are additionally transmitted, in case a request for the predetermined relevant pages is made from the client, the requested pages can be rapidly displayed on a screen of the monitor.

Moreover, the method further includes the steps of preparing high-resolution divided images for the original copy at step (a) which are provided according to a request for a detail image from the client, determining if a request for a transmission of a detail image is made from the client; and transmitting the high-resolution divided image in case a request for a detail image is made from the client.

Additionally, when the method further includes the steps of encoding log-in information of the client; and inserting the encoded information into a part of the high-resolution divided image, the information tracking illegal reproduction is able to be inserted with small amount of operation.

Additionally, when the method of transmitting images for an online publication further includes the steps of recognizing, in case of the request for the detail image from the client at the determining step, a part for which the request is made; and transmitting the high-resolution divided image at the transmitting step in order of the part of which a position is recognized at the recognizing step and the adjacent high-resolution divided images according to their distance from the part, images can be more rapidly transmitted to the client.

### BRIEF DESCRIPTION OF DRAWINGS

The above objects, features and advantages of the present invention will become more apparent from the following detailed description when taken in conjunction with the accompanying drawings, in which:

FIG. 1 is a structural diagram for showing a network where the method transmitting images of on-line publications of the present invention is embodied;

FIG. 2 is a view for showing images saved in an image server in FIG. 1;

FIG. 3 is a flow chart for explaining the method of transmitting images for online publication according to a preferred embodiment of the present invention;

FIGS. 4a to 4c are views illustrating a low-resolution integrated image, a middle-resolution integrated image and a high-resolution integrated image, which are displayed on a monitor of the client; and

FIG. 5 is a view showing images displayed on the client monitor in the state encoded by the steps in FIG. 3.

### BEST MODE FOR CARRYING OUT THE INVENTION

The method transmitting images of an on-line publication of the present invention will now be described with reference to the accompanying drawings.

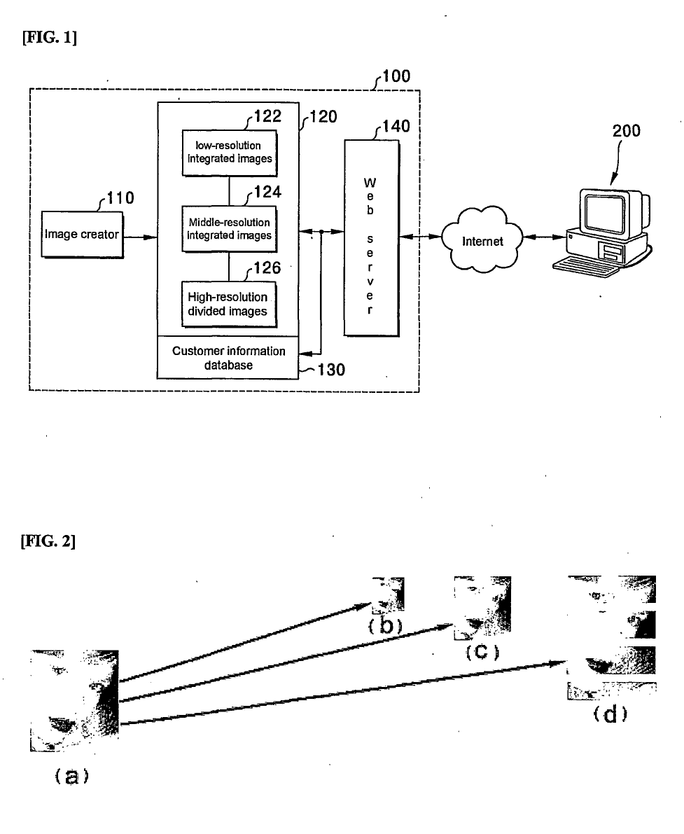

FIG. 1 is a structural diagram for showing a network where the method transmitting images of on-line publications of the present invention is embodied, and FIG. 2 is a view for showing images saved in an image server in FIG. 1. First, as shown in FIG. 1, the method for transmitting images of on-line publications is started by connecting a provider 100 of the on-line publication and a client 200 through an appropriate communication network, i.e. example Internet. The provider of the on-line publication (hereinafter, this is referred to as just “provider”) includes an image creator 110 creating images to be transmitted, an image server 120 saving the created images in the image creator 110, a customer information database 130 saving various information about the client 200, and a web server 140 performing a direct communication with the client 200.

In the cases of electronic materials the image creator 110 outputs by a general vector format images which have various formats used in software of the present publication industry, and then converts the images into JPEG (Joint Photographic Experts Group) format, while in the cases of off-line publications JPEG format images are created by a scanning process of a scanner.

As above, in the present invention, the standard format in the type of JPEG is used so that the client is able to watch the on-line publication embodied as images by using only a general web browser such as the Internet Explorer of Microsoft Company (Registered Trademark) without providing any separate exclusive software.

Meanwhile, the image creator 110 reduces an original image obtained as above such as “a” in FIG. 2 into for example its one sixteenths to create an integrated image having a relatively low resolution (hereinafter, it is referred to as “integrated image with low resolution) as shown in “b” in FIG. 2. The image creator 110 also reduces the original image into for example one fourth to create an integrated image having a relatively middle resolution (hereinafter, it is referred to as “integrated image with middle resolution) as shown in “c” in FIG. 2. Finally, the creator creates an image having n pieces (n: hereinafter is referred to as “division number”) into which the original image is divided as shown in “d” in FIG. 2 (hereinafter, this created image is referred to as “divided image with high resolution).

Additionally, the created images are saved in corresponding folders 122, 124, 126 separately according to a type of files by a download module of the image server 120 to transmit appropriately one of the images according to a selective request of the web server 140. At this case, the integrated image with low resolution may have a data amount of several hundreds byte to several Kb.

The web server 130 is embodied in a type of CGI (Common Gateway Interface) in general web server software using an existing HTTP (Hypertext Transfer protocol), and for example this server can be embodied in CGI of a ISAPI (Internet Server Application Program) type of IIS (Internet Information Server) server of the Microsoft Company.

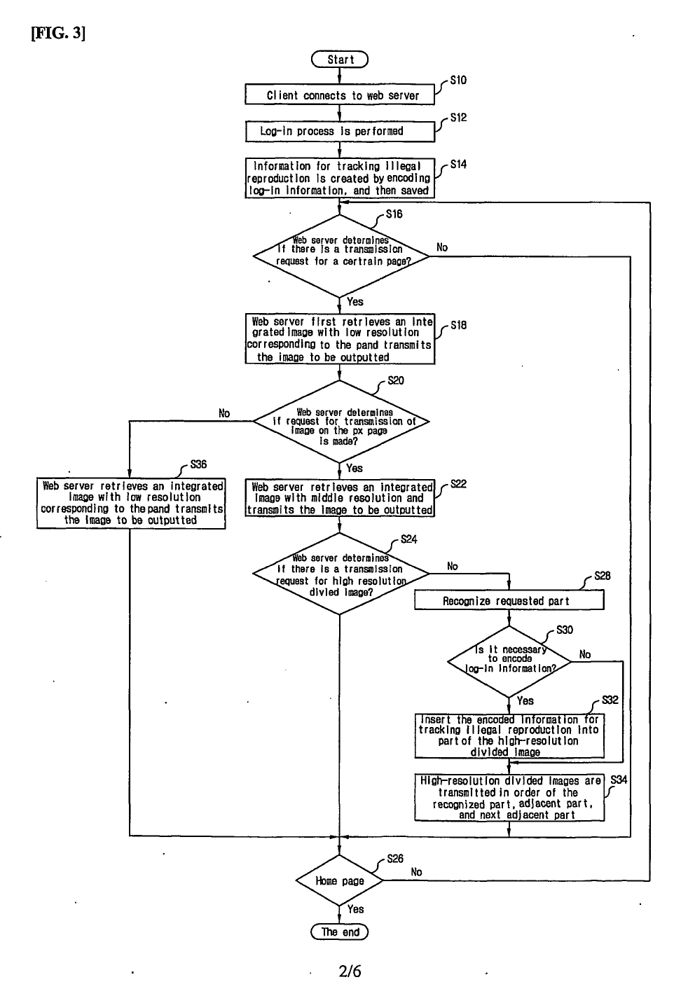

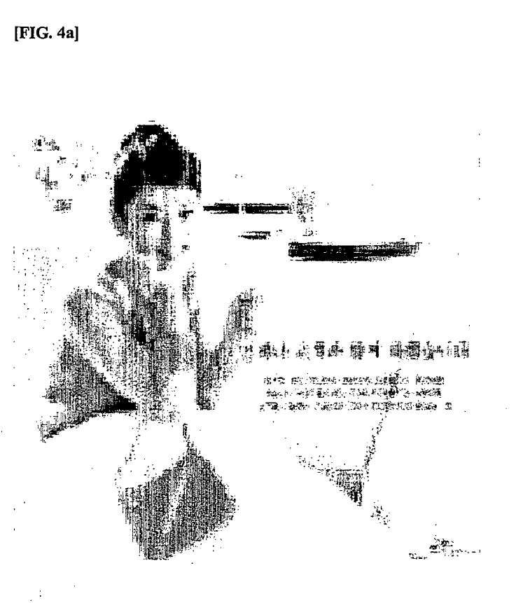

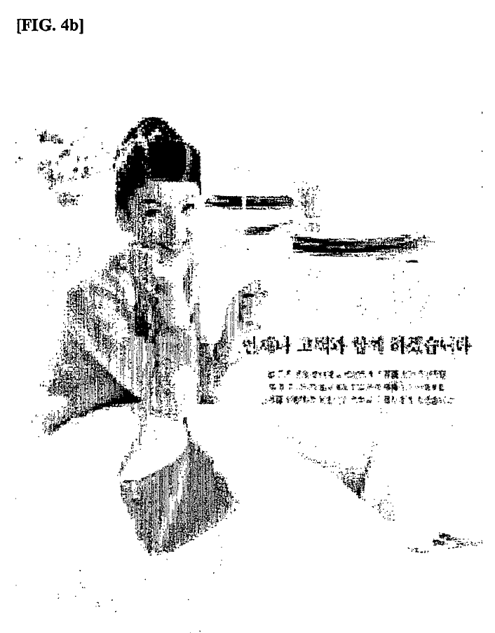

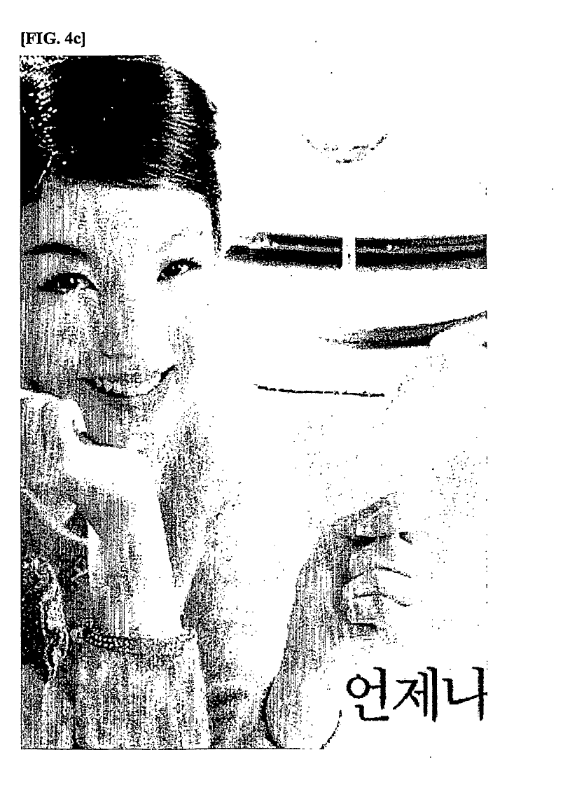

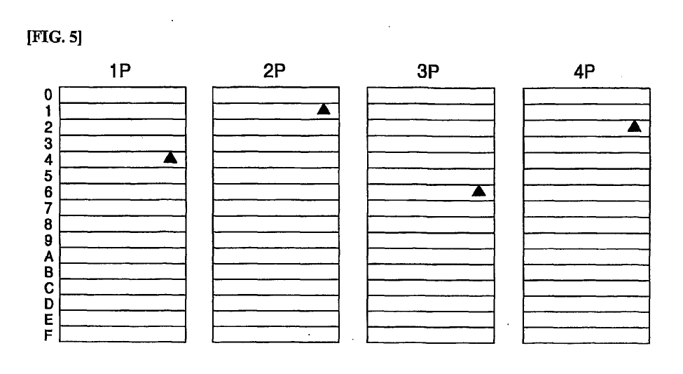

FIG. 3 is a flow chart for explaining the method of transmitting images for online publication according to a preferred embodiment of the present invention, and FIGS. 4a to 4c are views illustrating a low-resolution integrated image, a middle-resolution integrated image and a high-resolution integrated image which is displayed on a monitor of the client. First, as shown in FIG. 3, when the client 200 connects to the web server 140 of the provider 100 through Internet, etc. at step S10, a log-in process is performed at step S12. At this process, information such as an ID of the client 200, the connection date and time, an IP address of the client, and Check Sum data is recognized to be saved in customer information DB 130. As known, information such as an address, a telephone number or a resident registration number of the client may be obtained in advance for example in a step of member admission to be saved in the customer DB 130.

Next, at step S14, information for tracking illegal reproduction is created by encoding the obtained information from the above log-in process, and then the information is saved in the customer information database 130. In this case, for a method for encoding, a method in the n-digit number type, preferably larger than the 10-digit number type (hereinafter, this method is referred to as “information for tracking in the number type”) can be used. Additionally, it is preferred that the n referring to a digit corresponds with the division number n of the divided image with high resolution.

When information provided from the provider 100 is available for the client 200 after the above log-in process, at step S16 the web server 130 determines if there is a transmission request for a certain page in the on-line publication transmitted by this server (for example, p page) from the client 200. As a result of the determination at step 16, in case there is a transmission request from the client 200, at step S18 the web server 130 first retrieves an integrated image with low resolution corresponding to the p page from the image server 120 and transmits the image to be outputted on a monitor of the client 200.

Additionally, immediately after this process is completed, the web server allows a web browser of the client 200 to successively receive an integrated image with low resolution of a p+1 page or a p−1 page adjacent to the outputted p page and an integrated image with low resolution of a p+2 page or a p−2 page, and to save the images in its memory. At this case, it is preferred that the browser receives the pages in an order of the p+1 page, the p−1 page, the p+2 page, and finally the p−2 page. This background process is performed by a function of multi-tasking basically contained in the client 200, and several pages can be sufficiently transmitted for a short time of a second because the integrated image with low resolution is less than several Kb as mentioned above.

Meanwhile, a general web browser in the client 200 is basically provided with a stretching function, and the integrated image with low resolution transmitted at step S18 is magnified onto the whole screen of the monitor of the client 200 by this stretching function. Accordingly, the client (user) can recognize just an overall outline as shown in FIG. 4a.

After the client (user) recognized the image at the above state, if the image is not desired by the user, the user will request the web server 130 to immediately send another px page, normally an adjacent page (p+1 page or p−1 page). Considering the above process, at step S20 the web server determines if a request for a transmission of an image on the px page is made from the client 200 for example while 2 seconds to 10 seconds pass after the first request (preferably, while 3-5 seconds pass).

If, at the determination step S20, any request for transmission of an image on another page is not made from the client 200 until a certain time t passes, the web server 130 determines that the client 200 is interested in the p page displayed at the present time, and performs a step S22 to retrieve an integrated image with middle resolution of the p page from the image server 120 and transmit the image to the client 200. Thereafter, the client 200 overlays by its own function the transmitted integrated image with middle resolution on the integrated image with low resolution displayed at the present time. At this display process, the stretching function is also used. Therefore, the image of which details can be recognized to some extent as well as a whole outline is output as shown in FIG. 4b. Additionally, in case there is enough time, the image with middle resolution of the adjacent p+1 page, or p−1 page is transmitted to the client 200 to be saved.

Otherwise, if at step S20 the web server 130 receives a request for an image on another px page from the client 200 before the certain time t passes, the web server 130 performs a step S36 to retrieve an integrated image with low resolution of the requested px page from the image server 120 and output the image on the monitor of the client 200. As a matter of course, at this case, pages adjacent to the displayed px page are also transmitted to the client 200 to be saved in its own memory.

Meanwhile, if the page requested by the client 200 at step S36 is the p+1 page, the p−1 page, the p+2 page or the p−2 page which are adjacent to the p page (that is, if the page requested is the page of which the low-resolution integrated image has been already transmitted at step S18), the client 200 retrieves the same from its own memory to display it on the monitor so that a desired image can be rapidly displayed regardless of a transmission speed from the web server 130.

As explained above; according to the method of the present invention, the server allows the client to receive images of pages in advance, which are expected to be requested next time by the client, while the network has spare capacity so that the client can rapidly display the pages through its own operation at the request for the pages by the user. At this point, which page is to be transmitted in advance (or how many pages are to be transmitted in advance in what order) can be changed appropriately according to data amounts of pages or a transmission speed of the network.

Meanwhile, if the client 200 requests for a high-resolution image of the corresponding page while the low-resolution or the middle-resolution integrated image is being displayed on the monitor of the client 200 or when the display process is completed, the web server 130 recognizes the request at step S24 and performs a step S34 to retrieve and transmit the high-resolution divided image of the corresponding page from the image server 120.

For a convenience for the client 200 in this case, the web server 130 additionally performs a step S28 and recognizes a part which the client 200 specially wants to look at on the displayed page (here, a position of the part can be recognized for example by a clicked position by the client's mouse.). Additionally, for the process of step S34, it is preferred that a high-resolution divided image corresponding to the recognized part is transmitted first, and then high-resolution divided images of parts adjacent to the part are transmitted. That is, in case that the position clicked by the client 200 corresponds to a divided image in a c line, the divided image in the c line is first transmitted, and then divided images in a c−1 line and a c+1 line are transmitted and then divided images in a c−2 line and a c+2 line are transmitted.

Meanwhile, in case an encoding of the on-line publication is requested, a step S30 and a step S32 are additionally performed before the step S34, so that the above-mentioned information tracking an illegal reproduction is inserted to at least a part of the high-resolution divided image. For a method inserting the information tracking an illegal reproduction, for example a certain graphic element, which size is so large to be visually recognized even when the on-line publication is printed out, is inserted to the page corresponding to a position of a cipher's of the said number type tracking information.

FIG. 5 is a view showing images displayed on the client monitor in the state encoded by the steps in FIG. 3. As shown in FIG. 5, the insertion position of the graphic element on each page of high-resolution divided images is on a line corresponding to a number of each cipher of the number type tracking information. For example, if a number type tracking information produced for any client 200 is 416216 in 16 digits, the number of the high-resolution divided images is preferably 16, and at this case the number of pages having graphic elements inserted is total 4. In the first page, a graphic element is inserted into a fourth line of the high-resolution divided image corresponding to a number of the first cipher “4” of the number type tracking information. Similarly, in the second page, a graphic element is inserted into a first line of the high-resolution divided image corresponding to a number of the second cipher “1”. Similar processes are performed for a 3^{rd} page and 4^{th} page, thereby in case the whole on-line publication is illegally reproduced, recognizing a reproducer's identification by restoring the number type tracking information by pages having graphic elements inserted and decoding the information.

In this way, the present invention deals with only some divided images of whole images for the insertion of the tracking information so that an amount of operation is considerably reduced.

Meanwhile, during the foregoing steps, it is determined at step S26 if the client 200 wants to log out. When the client 200 wants to log out, the program is ended.

The present invention is not limited to the above embodiment, and various modifications are possible without departing from the scope and spirit of the invention as disclosed in the accompanying claims. For example, the high-resolution image is transmitted in the divided form in the above embodiment, but the high-resolution image may be transmitted as an integrated image as well.

In this case, it is a matter of course that the process with the information tracking an illegal reproduction will be applied to the integrated image.

According to the method transmitting images of an on-line publication as mentioned above, images with appropriate resolution are automatically selected and transmitted to the client by analyzing response of the client, thereby largely increasing the transmission speed without interfering the client's reading of the publication.

Additionally, for the insertion of the information tracking the illegal reproduction, the insertion is made into a divided part of the image, thereby largely reducing an amount of the insertion operation and increasing an operation efficiency of the relevant apparatus.

What is claimed is:

1. A method of transmitting images for an online publication performed by a provider of the online publication in a state that the provider and a client having a stretching function and a multi tasking function are connected to each other through a communication network, the method comprising steps of:
a) preparing, for a same original copy, relatively low-resolution integrated images and relatively middle-resolution integrated images which are to be transmitted to the client and magnified by the stretching function;
b) transmitting the corresponding low-resolution integrated image when a transmission for a certain page of the original copy is requested;
c) determining if a request for a transmission of another page of the original copy is made until a certain time passes after the transmission of the low-resolution integrated image;
d) transmitting, if it is determined at the step (c) that a request for a transmission of another page is made before the certain time passes, the low-resolution integrated image for the page; and
e) transmitting, if it is determined at the step (c) that a request for a transmission of another page is not made until the certain time passes, the middle-resolution integrated image for the certain page.

2. The method of transmitting images for an online publication according to claim 1, further comprising a step of additionally transmitting the low-resolution integrated images for predetermined relevant pages to the certain page, after the step of transmitting the low-resolution integrated image.

3. The method of transmitting images for an online publication according to claim 1, further comprising a step of additionally transmitting the low-resolution integrated images for predetermined relevant pages to the certain page, after the step of transmitting the middle-resolution integrated image.

4. The method of transmitting images for an online publication according to claim 2 or claim 3, further comprising the steps of:
(f) preparing high-resolution divided images for the original copy at step (a) which are provided according to a request for a detail image from the client;
(g) determining if the request for a transmission of the detail image is made from the client; and
(h) transmitting the high-resolution divided image in case the request for the detail image is made from the client.

5. The method of transmitting images for an online publication according to claim 4, further comprising the steps of (i) encoding log-in information of the client; and (j) inserting the encoded information into a part of the high-resolution divided image.

6. The method of transmitting images for an online publication according to claim 4, further comprising the steps of (g1) recognizing, in case of the request for the detail image from the client at the step (g), a part for which the request is made; and (h1) of transmitting the high-resolution divided image at the step (h) in order of the part of which a position is recognized at the step (g1) and the adjacent high-resolution divided images according to their distance from the part.
